(19) United States
(12) Patent Application Publication
(10) Pub. No.: US 2020/0013020 A1
(43) Pub. Date: Jan. 9, 2020

(54) METHODS AND SYSTEMS FOR CARPOOLING

(71) Applicant: BEIJING DIDI INFINITY TECHNOLOGY AND DEVELOPMENT CO., LTD., Beijing (CN)

(72) Inventors: Baotong YANG, Beijing (CN); Wenwen XU, Beijing (CN); Mingzhe HE, Beijing (CN); Qi XIAO, Beijing (CN); Yang LIU, Beijing (CN); Tihui ZHANG, Beijing (CN); Zhipeng ZUO, Beijing (CN); Binbin HE, Beijing (CN); Jianhong HAN, Beijing (CN); Haiming LU, Beijing (CN); Qijia ZHANG, Beijing (CN); Yaorong SHI, Beijing (CN); Erpeng GAO, Beijing (CN); Zemin XIA, Beijing (CN); Keke WANG, Beijing (CN); Mingshan LUO, Beijing (CN); Kehua SHENG, Beijing (CN); Baihu CHEN, Beijing (CN); Meng AI, Beijing (CN); Ji HU, Beijing (CN); Haiyun ZHANG, Beijing (CN); Yucen LIU, Beijing (CN); Yangbiao LIU, Beijing (CN); Kuan SHI, Beijing (CN); Zhihao OU, Beijing (CN); Bo WANG, Beijing (CN); Xudong ZHANG, Beijing (CN); Junying ZHANG, Beijing (CN); Long ZHANG, Beijing (CN); Xiaodong HUANG, Beijing (CN); Fenglei WANG, Beijing (CN)

(73) Assignee: BEIJING DIDI INFINITY TECHNOLOGY AND DEVELOPMENT CO., LTD., Beijing (CN)

(21) Appl. No.: 16/576,219

(22) Filed: Sep. 19, 2019

Related U.S. Application Data
(63) Continuation of application No. PCT/CN2017/077795, filed on Mar. 23, 2017.

(51) Int. Cl. G06Q 10/10

(52) U.S. Cl. CPC G06Q 10/1095

(57) ABSTRACT

The present disclosure relates to systems and methods for carpooling. The systems may perform the methods to receive a first intention for a first transportation service of a first subject from a first service requester at a first service intention time; identify an available service provider at the first service intention time; send the service provider a first time point to arrive at a pick-up location and a wait time to stop at the pick-up location before departing from the pick-up location; and send the first service requester a second time point to arrive at the pick-up location.

### CROSS-REFERENCE TO RELATED APPLICATIONS

This application is a continuation of International Application No. PCT/CN2017/077795, filed on Mar. 23, 2017, the contents of which are incorporated herein by reference to its entirety.

### TECHNICAL FIELD

The present disclosure generally relates to an on-demand service system, and more particularly, to methods and systems for carpooling.

### BACKGROUND

A carpooling transportation service refers to an arrangement that combines two or more transportation services into a new transportation service. The carpooling transportation service may improve the traffic capacity. However, there are some problems such as inefficiency and a bad user experience in existing systems and methods for carpooling. Therefore, it is desirable to provide systems and methods for carpooling to improve the efficiency and the user experience.

### SUMMARY

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

According to an aspect of the present disclosure, a system may include one or more storage media and one or more processors configured to communicate with the one or more storage media. The one or more storage media may include a set of instructions for carpooling. When the one or more processors executing the set of instructions, the one or more processors may be directed to perform one or more of the following operations. The one or more processors may receive a first intention for a first transportation service of a first subject from a first service requester at a first service intention time. The one or more processors may identify an available service provider at the first service intention time. The one or more processors may send the service provider a first time point to arrive at a pick-up location and a wait time to stop at the pick-up location before departing from the pick-up location. The one or more processors may send the first service requester a second time point to arrive at the pick-up location.

In some embodiments, the one or more processors may determine a second intention for a second transportation service of a second subject from a second service requester. The one or more processors may determine a first hold off time. The one or more processors may provide a higher priority to the first service requester and the second service requester over a plurality of other service requesters communicated to the online transportation service platform in allocating the service provider within the first hold off time.

In some embodiments, the one or more processors may receive a destination of the first transportation service from the first service requester. The one or more processors may determine that the first service requester intents to request the first transportation service before receiving a request of the first transportation service from the first service requester.

In some embodiments, the one or more processors may receive a destination of the second transportation service from the second service requester. The one or more processors may determine that the second service requester intents to request the first transportation service before receiving a request of the second transportation service from the second service requester.

In some embodiments, the one or more processors may determine an estimated travel time that the service provider will need to arrive at the pick-up location. The one or more processors may determine the first time point and the second time point based on the estimated travel time.

In some embodiments, the one or more processors may determine a buffer time based on the estimated travel time and the wait time.

In some embodiments, the one or more processors may determine that the buffer time is larger than a threshold. The one or more processors may determine the second time point based on the estimated travel time and the wait time.

In some embodiments, the one or more processors may determine that the buffer time is less than or equal to a threshold. The one or more processors may determine a second hold off time based on the threshold and the buffer time. The one or more processors may determine the second time point based on the second hold off time, the estimated travel time, and the wait time.

In some embodiments, the threshold may be an estimated time between the first service intention time and a third service intention time of a third intention, and the third intention may be a hypothetical intention of which a third transportation service is combined with the first transportation service.

In some embodiments, the subject may be one or more passengers and the service may be a taxi service.

In some embodiments, the subject may be one or more goods and the service may be a goods delivery service.

According to another aspect of the present disclosure, a method may include one or more of the following operations. A computer server of an online on-demand transportation service platform may receive a first intention for a first transportation service of a first subject from a first service requester at a first service intention time. The computer server may identify an available service provider at the first service intention time. The computer server may send the service provider a first time point to arrive at a pick-up location and a wait time to stop at the pick-up location before departing from the pick-up location. The computer server may send the first service requester a second time point to arrive at the pick-up location.

In some embodiments, the computer server may determine a second intention for a second transportation service of a second subject from a second service requester. The computer server may determine a first hold off time. The computer server may provide a higher priority to the first service requester and the second service requester over a plurality of other service requesters communicated to the online transportation service platform in allocating the service provider within the first hold off time.

In some embodiments, the computer server may receive a destination of the first transportation service from the first service requester. The computer server may determine that the first service requester intents to request the first transportation service before receiving a request of the first transportation service from the first service requester.

In some embodiments, the computer server may receive a destination of the second transportation service from the second service requester. The computer server may determine that the second service requester intents to request the first transportation service before receiving a request of the second transportation service from the second service requester.

In some embodiments, the computer server may determine an estimated travel time that the service provider will need to arrive at the pick-up location. The computer server may determine the first time point and the second time point based on the estimated travel time.

In some embodiments, the computer server may determine a buffer time based on the estimated travel time and the wait time.

In some embodiments, the computer server may determine that the buffer time is larger than a threshold. The computer server may determine the second time point based on the estimated travel time and the wait time.

In some embodiments, the computer server may determine that the buffer time is less than or equal to a threshold. The computer server may determine a second hold off time based on the threshold and the buffer time. The computer server may determine the second time point based on the second hold off time, the estimated travel time, and the wait time.

In some embodiments, the threshold may be an estimated time between the first service intention time and a third service intention time of a third intention, and the third intention may be a hypothetical intention of which a third transportation service is combined with the first transportation service.

In some embodiments, the subject may be one or more passengers and the service may be a taxi service.

In some embodiments, the subject may be one or more goods and the service may be a goods delivery service.

### BRIEF DESCRIPTION OF THE DRAWINGS

FIG. 1 is a block diagram of an exemplary on-demand service system 100 according to some embodiments.

FIG. 2 is a schematic diagram illustrating exemplary hardware and software components of a computing device 200 according to some embodiments of the present disclosure.

FIG. 3 is a block diagram illustrating an exemplary architecture of processing engine 112 according to some embodiments of the present disclosure.

FIG. 4 is a flowchart illustrating an exemplary process of a carpooling transportation service according to some embodiments of the present disclosure.

FIG. 5 is a flowchart illustrating an exemplary process of providing a priority in allocating a service provider according to some embodiments of the present disclosure.

FIG. 6 is a flowchart illustrating an exemplary process of determining a first time point according to some embodiments of the present disclosure.

FIG. 7 is a flowchart illustrating an exemplary process of determining a second time point according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to allocate a set of sharable orders, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to online systems and methods for a carpooling transportation service. In some embodiments, an application installed in a requester terminal may direct the requester terminal to constantly monitoring inputs from a service requester and send the input to the online system in the present disclosure. Consequently, the requester terminal may inform the service requester's input to the online system in the present disclosure in real-time or substantially real-time. As a result, when the service requester input part of the information of the transportation service, the online system in the present disclosure may receive enough information to determine an intention of the service requester. For example, when the service requester input a destination of the transportation service, and before sending out the transportation service request to the online system in the present disclosure, the online system in the present disclosure may have already received the destination and determine that the service requester intends to request a transportation service to the destination. After receiving the intention, the online system in the present disclosure may identify a service provider that is available for the transportation service. The online system in the present disclosure may send a first time point for the service provider to arrive at a pick-up location and a wait time to stop at the pick-up location before departing from the pick-up location to the service provider, and send a second time point for the service requester to arrive at the pick-up location. Further, the online system may detect service request intention of a second service requester and arrange a carpool service for the first requester and the second requester.

It should be noted that online on-demand transportation service, such as online carpool service, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). If a driver wants to provider a carpool service, the driver has to ask a passenger face to face and determine whether the carpooling service is possible to be provided to the passenger by experience of the driver. Online carpool service, however, obtains transaction requests and finds combinable transaction requests in real-time and automatically. The carpool service also allows a user of the service to real-time and automatic distribute a service request to a vast number of individual service providers (e.g., taxi) distance away from the user and allows a plurality of service provides to respond to the service request simultaneously and in real-time. Therefore, through Internet, the online on-demand transportation systems may provide a much more efficient transaction platform for the users and the service providers that may never met in a traditional pre-Internet transportation service system.

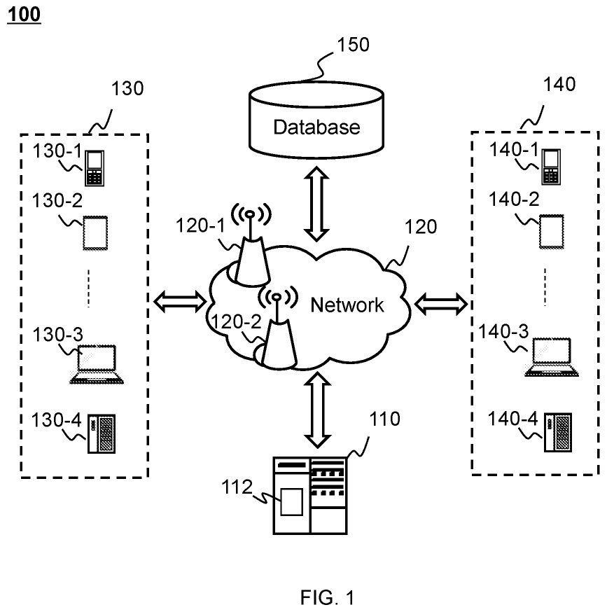

FIG. 1 is a block diagram of an exemplary on-demand service system 100 according to some embodiments. For example, the on-demand service system 100 may be an online transportation service platform for transportation services such as taxi hailing, chauffeur service, express car, carpool, bus service, driver hire and shuttle service. The on-demand service system 100 may be an online platform including a server 110, a network 120, a requestor terminal 130, a provider terminal 140, and a database 150. The server 110 may include a processing engine 112.

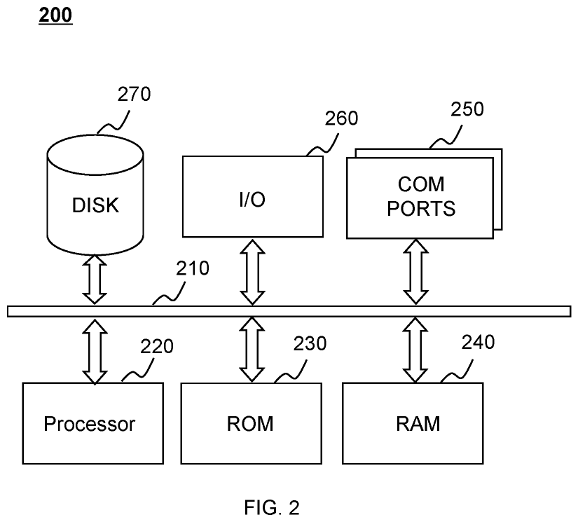

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine a target vehicle based on the service request obtained from the requestor terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the requestor terminal 130, the provider terminal 140, and the database 150) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with other positioning device to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140, etc.). In some embodiments, the database 150 may be part of the server 110.

In some embodiments, one or more components in the on-demand service system 100 (e.g., the server 110, the requestor terminal 130, the provider terminal 140, etc.) may have a permission to access the database 150. In some embodiments, one or more components in the on-demand service system 100 may read and/or modify information relating to the requestor, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O 260, supporting input/output between the computer and other components therein such as user interface elements. The computing device 200 may also receive programming and data via network communications.

Merely for illustration, only one processor is described in the computing device 200. However, it should be note that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

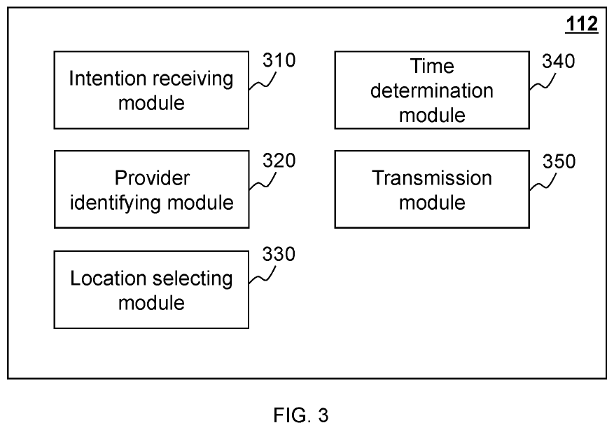

FIG. 3 is a block diagram illustrating an exemplary architecture of processing engine 112 according to some embodiments of the present disclosure. As illustrated, processing engine 112 may include an intention receiving module 310, a provider identifying module 320, a location selecting module 330, a time determination module 340 and a transmission module 350. The modules may be hardware circuits of all or part of the processing engine 112. The modules may also be implemented as an application or set of instructions read and executed by the processing engine. Further, the modules may be a combination of the hardware circuits and the application/instructions. For example, the modules may be the part of the processing engine 112 when the processing engine is executing the application/set of instructions.

The intention receiving module 310 may be configured to receive and/or detect an intention for a transportation service of a subject from a service requester at a service intention time. In some embodiments, the transportation service may be a service of taking one or more subjects from one place to another in a vehicle. The subject may include passengers and/or goods. For example, the transportation service may be a taxi service or a goods delivery service. In some embodiments, for a taxi service, if the subject of the intention includes one or more passengers, the service requester may be one of the passengers, or the service requester may be one that is not included in the passengers. For example, if the service requester intents to request a taxi for another person, the service requester may be different from the passenger. The vehicle may include a non-motor vehicle (e.g., a bicycle or a tricycle), a motor vehicle (e.g., a motorcycle, a car, or a truck), a watercraft (e.g., a ship or a boat) and/or an aircraft.

In some embodiments, the intention receiving module 310 may receive and/or detect the intention by receiving and/or sensing information of the transportation service from the service requester, and determining that the service requester intents to request the transportation service before receiving a request of the transportation service from the service requester. In some embodiments, the information of the transportation service may include an origin, a destination, a start time, a space that the subject needs (e.g., the number of passengers or the volume of goods), or the like, or any combination thereof. In some embodiments, the information of the transportation service may be input by the service requester. In some embodiments, the information of the transportation service may be determined by requester terminal 130. For example, requester terminal 130 may determine the origin and/or the destination according to the positioning technology (e.g., GPS) and/or historical data.

In some embodiments, the request of the transportation service may refer to the information of the transportation service that is formally sent out by a service requester. In some embodiments, if the information of the transportation service is formally sent out, it may mean that the information of the transportation service is sent out by the service requester through the requester terminal 130. For example, the requester terminal 130 may install an application for sending out the transportation service request. Through an interface of the application, the requester terminal 130 may establish connection and communicate with the system 100. When the service requester sends out the information of the transportation service to the intention receiving module 310, the service requester may do so by pressing a button on the interface. Upon receiving the request by the system 100, the intention receiving module 310 may determine that the information of the transportation service is formally sent out and determine the information of the transportation service as a request.

In some embodiments, the application installed in the requester terminal may direct the requester terminal to constantly monitoring inputs from the service requester and send the input to the system 100. Consequently, the requester terminal may inform the service requester's input to the system 100 in real-time or substantially real-time. As a result, when the service requester input part of the information of the transportation service, the system 100 may receive enough information to determine an intention of the service requester. For example, when the service requester input a destination of the transportation service, and before sending out the transportation service request to the system 100, the system 100 may have already received the destination and determine that the service requester intends to request a transportation service to the destination.

In some embodiments, the service intention time may refer to a time when the service requester inputs the information of the transportation service and/or when requester terminal 130 determines the information of the transportation service before the intention receiving module 310 receives a request of the transportation service. For example, the intention receiving module 310 may determine a time when the service requester inputs the destination of the transportation service to be the service intention time. Alternatively, because receiving and determination of the service intention may occur almost immediately when the service requester inputs part of the information of the transportation service, the intention receiving module 310 may determine that the service intention time to be the time that the intention receiving module 310 receives enough information (e.g., the destination) to determine the service intention.

In some embodiments, the transportation service may be a real-time transportation service or a transportation service appointment. As used herein, a real-time transportation service may be a service that the requester wishes to conduct the requested transaction (e.g., transportation service) at the present moment or at a defined time reasonably close to the present moment for an ordinary person in the art, so that a service provider is required to depart immediately or substantially immediately after the system 100 receives the service request. For example, an intention may be for real-time transportation service if the defined time is shorter than a threshold value, such as 1 minute, 5 minutes, or 10 minutes. The transportation service that needs to make an appointment refer to a service that the requester wishes to conduct the requested transaction at a defined time which is reasonably far from the present moment for the ordinary person in the art, so that a service provider is not required to depart immediately or substantially immediately after the system 100 receives the service request. For example, a transportation service may need an appointment if the defined time is longer than a threshold value, such as 20 minutes, 2 hours, or 1 day. In some embodiments, the processing engine 112 may define the real-time transportation service or the transportation service appointment based on a time threshold. The time threshold may be default settings of system 100, or may be adjustable depending on different situations. For example, in a traffic peak period (e.g., 7:00 am-9:00 am), the time threshold may be relatively small (e.g., 10 minutes), otherwise in an idle period (e.g., 10:00 am-12:00 am), the time threshold may be relatively large (e.g., 1 hour).

The provider identifying module 320 may be configured to identify an available service provider at and/or after the service intention time. In some embodiments, the available service provider may refer to a service provider that is applicable to provide a carpooling transportation service to the service requester at and/or near intended time of the transportation service. In some embodiments, the provider identifying module 320 may identify the available service provider according to factors such as whether to provide a carpooling transportation service, the available space of the vehicle of the service provider, the distance between the service provider at the service intention time and the origin of the intention, or the like, or any combination thereof. For example, if a service provider does not provide the carpooling transportation service (e.g., carpooling service for passenger or goods), the provider identifying module 320 may not determine the service provider as the available service provider. As another example, for a taxi service, if the number of the available seat of the vehicle of a service provider is 1, and the number of passengers of the intention is 2, the provider identifying module 320 may not determine the service provider as the available service provider.

In some embodiments, two or more transportation services may be combined into a carpooling transportation service. For example, two taxi services may be combined into a carpooling transportation service. As another example, two goods delivery services may be combined into a carpooling transportation service. The third example is that a taxi service and a goods delivery service may be combined into a carpooling transportation service.

The location selecting module 330 may be configured to select a pick-up location for the intention. In some embodiments, the pick-up location may refer to a location where the service provider picks up the subject. In some embodiments, the pick-up location and the origin of the intention may be same or different.

The time determination module 340 may be configured to determine a first time point, a second time point, and a wait time. In some embodiments, the first time point may refer to a time point when the service provider arrives at the pick-up location. The second time point may refer to a time point when the subject arrives at the pick-up location. The wait time may refer to a period of time that the service provider stops at the pick-up location before departing from the pick-up location.

The transmission module 350 may be configured to send the first time point and the pick-up location to the service provider, and send the second time point and the pick-up location to the service requester and/or the subject (e.g., a passenger).

In some embodiments, the service provider, the service requester and the subject (e.g., a passenger and/or goods) may respectively use an electronic device to communicate with the on-demand service system 100 via the network 120. The device may include a desktop, an All-in-One personal computer (AlO), a notebook, a smartphone, a Personal Digital Assistant (PDA), a tablet, a carputer, a handheld game player, a wearable device (e.g., smart glasses or smartwatch), a virtual display device (e.g., Oculus Rift or Gear VR), an augmented display device (e.g., Google Glass, Hololens), or the like, or any combination thereof. For example, the system 100 may serve as an on-demand transportation service platform, through which the service requester may use a requester terminal (e.g., a smart phone) to communicate with a provider terminal (e.g., a smart phone) of the service provider.

The modules in processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the location selecting module 330 may be integrated in the time determination module 340 as a single module which may both select the pick-up location and determine the first time point, the second time point and the wait time. As another example, the time determination module 340 may be divided into three units. The first unit may be configured to determine the first time point. The second unit may be configured to determine the second time point. The third unit may be configured to determine the wait time. The third example is that transmission module may be divided into two units. One unit may be configured to send the first time point, the wait time and the pick-up location to the service provider. The other one may be configured to send the second time point and the pick-up location to the service requester.

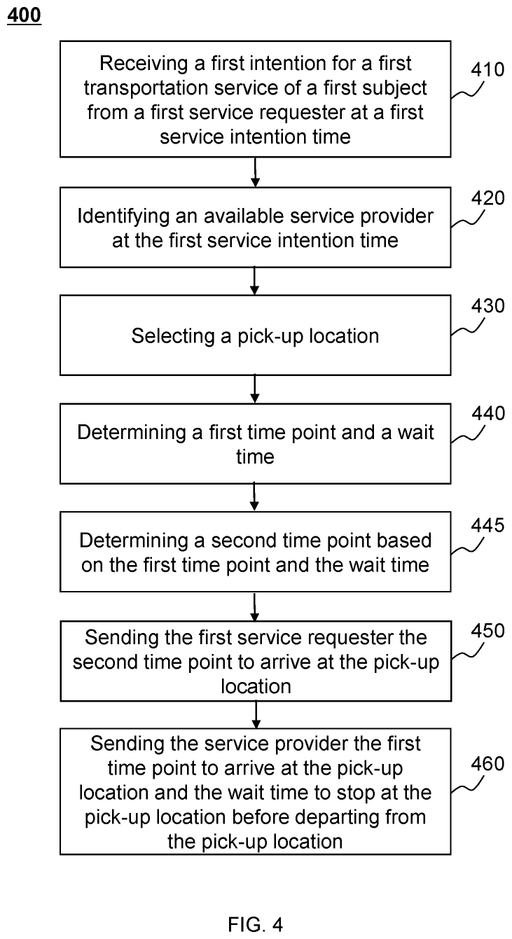

FIG. 4 is a flowchart illustrating an exemplary process of a carpooling transportation service according to some embodiments of the present disclosure. In some embodiments, the process 400 may be implemented in the system 100 illustrated in FIG. 1. For example, the process 400 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3).

In step 410, the intention receiving module 310 may receive and/or detect a first intention for a first transportation service of a first subject from a first service requester at a first service intention time.

In some embodiments, the intention receiving module 310 may receive and/or detect the first intention by receiving and/or sensing information of the first transportation service from the first service requester, and determining that the first service requester intents to request the first transportation service before receiving a request of the first transportation service from the first service requester. For example, as described above, the requester terminal 130 may install an application for sending out the transportation service request. Through an interface of the application, the requester terminal 130 may establish connection and communicate with the system 100. The application may direct the requester terminal to constantly monitoring inputs from the service requester and send the input to the system 100. As a result, when the service requester input part of the information of the transportation service, such as a destination, the system 100 may receive enough information in real-time or substantially real-time to determine an intention of the service requester. For example, when the first service requester inputs a destination of the first transportation service and before sending out the transportation service request to the system 100, the intention receiving module 310 may receive and/or detect the destination from the first service requester in real-time or substantially real-time, and determine that the first service requester intents to request the first transportation service before receiving a request of the first transportation service from the first service requester.

In some embodiments, the intention receiving module 310 may further determine one or more transportation services that are possible to be combined with the first transportation service at and/or after the first service intention time. In some embodiments, the transportation service that is possible to be combined with the first transportation service may correspond to an intention or a request. In some embodiments, the transportation service that is possible to be combined with the first transportation service may correspond to a request that has been accepted by a service provider, or a request that has not been accepted by any service provider. In some embodiments, the pick-up location of the transportation service that is possible to be combined with the first transportation service and the pick-up location of the first transportation service may be same or different. In some embodiments, the intention receiving module 310 may determine the one or more transportation services that are possible to be combined with the first transportation service based on the origin of the first transportation service, the destination of the first transportation service, the origin of the second transportation service, the destination of the second transportation service, the pick-up location of the second transportation service, the start time of the first transportation service, the start time of the second transportation service, or the like, or any combination thereof.

In step 420, the provider identifying module 320 may identify an available service provider at and/or after the first service intention time.

In some embodiments, the provider identifying module 320 may identify the available service provider according to a factor of whether to provider a carpooling transportation service, the available space of the vehicle of the service provider, the distance between the service provider at the service intention time and the origin of the intention, or the like, or any combination thereof. For example, if a service provider does not provide the carpooling transportation service, provider identifying module 320 may determine the service provider as an unavailable service provider. As another example, for a taxi service, if the number of the available seat of the vehicle of a service provider is 1, and the number of passengers of the intention is 2, the provider identifying module 320 may determine the service provider as an unavailable service provider.

In step 430, the location selecting module 330 may select a pick-up location for the first intention.

In some embodiments, the location selecting module 330 may select the pick-up location according to the distance between the pick-up location and the origin of the first intention, the distance between the pick-up location and the location of the service provider at the first service intention time, a factor that whether parking is allowed at the pick-up location, or the like, or any combination thereof. In some embodiments, the location selecting module 330 may determine the pick-up location in real-time. In some embodiments, the location selecting module 330 may determine a plurality of candidate locations in a predetermined area in advance. The location selecting module 330 may select the pick-up location from the plurality of candidate locations.

In step 440, the time determination module 340 may determine a first time point and a wait time.

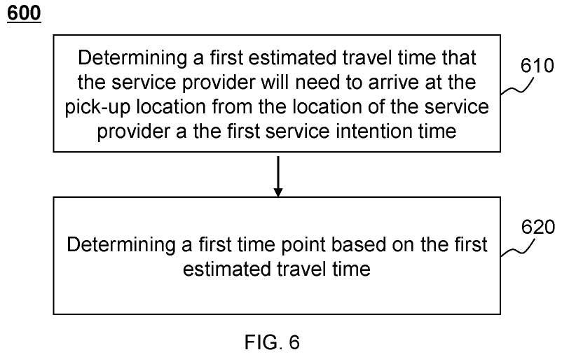

In some embodiments, for a real-time transportation service, the time determination module 340 may determine a first estimated travel time that the service provider will need to arrive at the pick-up location from the location of the service provider at the first service intention time. The time determination module 340 may determine the first time point according to the first estimated travel time and the first service intention time. In some embodiments, for a real-time transportation service, the time determination module 340 may determine the first time point according to, for example, the process 600 that will be described in detail in connection with FIG. 6.

For a transportation service appointment, the time determination module 340 may determine the first time point according to the start time of the transportation service appointment and the wait time. For example, in a scenario where a passenger plan to request a real-time taxi service, the passenger may input a destination at 10:00 pm into a taxi hailing application installed in his/her smart phone. the intention receiving module 310 may receive and/or detect that the passenger intends to request the taxi service immediately at 10:00 pm, after receiving the destination. The system 100 may select a taxi driver and a pick-up point close to where the passenger is in 10:01 pm. The system 100 then may determine that it would take the taxi driver 5 minutes to drive to the pick-up location. The system may further determine that the driver should wait for the passenger at the pick-up location for 5 minutes. Accordingly, the system 100 may instruct the driver, through a message to the driver's smart phone, to depart immediately and wait for the passenger at the pick-up location between 10:06 pm and 10:11 pm. The system 100 may also instruct the driver to timely arrive the pick-up location (e.g., before 10:11 pm).

To further enhance user experiences, the system 100 may further create a hold off time to hold off the instruction to the driver or the passenger, so that the driver arrives the pick-up location before the passenger. For example, in case that the passenger is very close to the pick-up location, such as 1 minute walking distance from the pick-up location, the system 100 may determine the hold off time anywhere between 4 minutes and 9 minutes, so that when the passenger spends 1 minute to walk to the pick-up location, the driver has already been there waiting for the passenger. Similarly, if the driver needs shorter time than the passenger to arrive the pick-up location, the system may determine a hold off time for the driver so that the driver arrives the pick-up location earlier than the passenger but does not need to wait for a long time (e.g., no more than a predetermined time period, such as 5 minutes).

In some embodiments, the wait time may be default settings of system 100 (e.g., 5 minutes), or may be adjustable depending on different situations. For example, in a traffic peak period (e.g., 7:00 am-9:00 am), the time determination module 340 may determine a relative short wait time (e.g., 3 minutes). In an idle period (e.g., 10:00 am-12:00 am), the time determination module 340 may determine a relative long wait time (e.g., 6 minutes). As another example, if the pick-up location corresponds to more than one transportation service, the time determination module 340 may determine a relative long wait time (e.g., 6 minutes). If the pick-up location corresponds to one transportation service, the time determination module 340 may determine a relative short wait time (e.g., 3 minutes).

In step 445, the time determination module 340 may determine a second time point based on the first time point and the wait time.

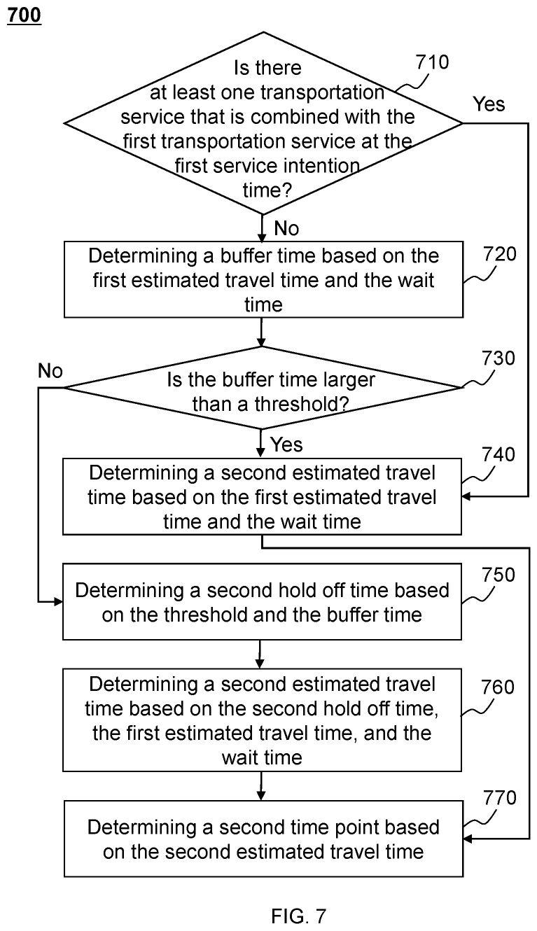

In some embodiments, for a real-time transportation service, the time determination module 340 may determine a second estimated travel time. In some embodiments, the second estimated travel time may refer to a period of time that is allowed by the online transportation service platform (e.g., server 110) for the first subject to arrive at the pick-up location from the origin place of the first intention. The time determination module 340 may determine the second estimated travel time based on the first estimated travel time and the wait time. The time determination module 340 may determine the second time point according to the second estimated travel time and the first service intention time. In some embodiments, for a real-time transportation service, the time determination module 340 may determine the second time point according to, for example, the process 700 that will be described in detail in connection with FIG. 7.

For a transportation service appointment, the time determination module 340 may determine the second time point according to the start time of the transportation service appointment. For example, the time determination module 340 may determine the start time of the transportation service appointment as the second time point.

In step 450, the transmission module 350 may send the first service requester and/or the first subject the second time point to arrive at the pick-up location. In another words, the transmission module 350 may instruct the first service requester to arrive at the pick-up location at the second time point.

For requester terminal 130, when receiving the second time point to arrive at the pick-up location, requester terminal 130 may display the second time point and the pick-up location. In some embodiments, requester terminal 130 may display the second time point and the pick-up location in a format of text, image, video, sound, or the like, or any combination thereof. For example, requester terminal 130 may display a text showing “Please arrive at National Library at or before 10:12 am.” As another example, requester terminal 130 may display the pick-up location on a map of requester terminal 130. Requester terminal 130 may also display a button to formally send out the information of the transportation service. After the first service requester formally sends out the information of the transportation service, requester terminal 130 may display service provider information. The service provider information may include the name of the service provider, the plate number of the vehicle of the service provider, the information of the vehicle (e.g., the color of the vehicle, or the brand of the vehicle) of the service provider, the contact information of the service provider (e.g., the phone number), or the like, or any combination thereof. In some embodiments, requester terminal 130 may display a map. On the map, requester terminal 130 may display information of the carpooling transportation service including the first transportation service, for example, a route of the carpooling transportation service, one or more pick-up locations of the carpooling transportation service, subject information of at least one of the pick-up locations (e.g., the number of subjects, the location(s) of the subject(s), or the destination(s) of the subject(s)), the location of the service provider, or the like, or any combination thereof.

In step 460, the transmission module 350 may send the service provider the first time point to arrive at the pick-up location and the wait time to stop at the pick-up location before departing from the pick-up location.

In some embodiments, the transmission module 350 may send the first time point and the wait time after the intention receiving module 310 receives a request of the first transportation service from the first service requester. In some embodiments, before step 460, the transmission module 350 may determine that the intention receiving module 310 has received a request of the first transportation service from the first service requester.

Similar to the requester terminal 130 that installs the application in its non-transitory storage medium to send a transportation service request, the provider terminal 140 may also install an application in its non-transitory storage medium an application to receive the request and other instructions and/or information from the system 10. The application installed in the provider terminal may be different or may be the same as the application installed in the requester terminal. For provider terminal 140, a processor of the provider terminal may execute the application and may be directed by the application. When receiving the first time point to arrive at the pick-up location, provider terminal 140 may display the first time point and the pick-up location. When provider terminal 140 determines that the service provider has arrived at the pick-up location, provider terminal 140 may display the wait time. In some embodiments, provider terminal 140 may display the first time point, the pick-up location, and the wait time in a format of text, image, video, sound, or the like, or any combination thereof. For example, provider terminal 140 may display a text showing “Please arrive at National Library at or before 10:07 am.” As another example, provider terminal 140 may display a text showing “The wait time is 5 minutes, and the departure time is 10:12 am.” The third example is that provider terminal 140 may display a countdown clock of the wait time.

In some embodiments, if provider terminal 140 determines that it is time to depart from the pick-up location or the service provider has picked up all of the subjects of the pick-up location, provider terminal 140 may display a button of departing from the pick-up location.

In some embodiments, provider terminal 140 may display, for example, the contact information of the first subject (e.g., the phone number), the destination of the first subject, the pick-up location of the first subject, or the like, or any combination thereof.

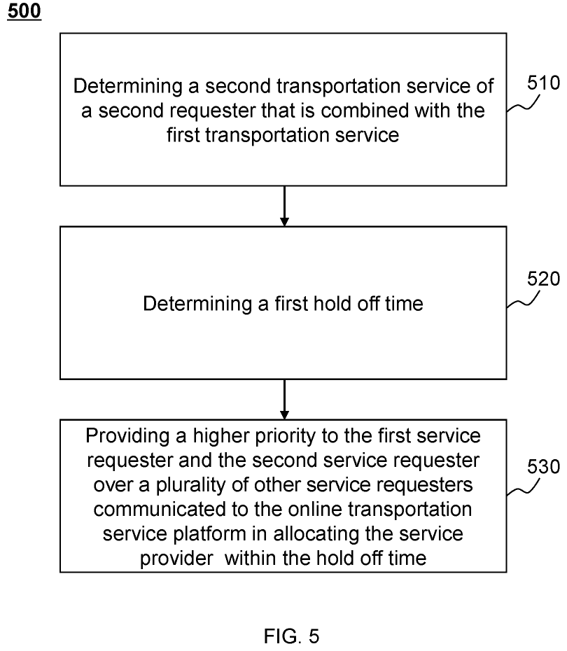

FIG. 5 is a flowchart illustrating an exemplary process for combining a second transportation service with the first transportation service, and providing a higher priority in allocating a service provider according to some embodiments of the present disclosure. In some embodiments, the process 500 may be implemented in the system 100 illustrated in FIG. 1. For example, the process 500 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3)

After receiving the first transportation service intention and/or after receiving the first transportation service request, the intention receiving module 310 may receive one or more other transportation service requests that accept carpool service. The intention receiving module 310 may select one of the one or more transportation service requests as the second transportation service request, and provide a carpool service to the first service requester and a second service requester. To this end, the intention receiving module 310 may receive real-time or substantially real-time transportation service information from a second requester terminal, and determine, based on the transportation service information, a second intention for the second transportation service.

To provide the carpool transportation service, the provider identifying module 320 may identify an available service provider to provide the carpool service to the first requester and the second requester. The provider identifying module 320 may identify the service provider after both the first intention and the second intention are received. Alternatively, the provider identifying module 320 may identify the service provider after step 420. Further, the system 100 may then give the first transportation service and/or the second transportation service higher priority to receive service from the service provider over a single transportation service.

For example, when the provider identifying module 320 identifies an available service provider for the first intention, the first service requester may have not sent out a request of the first transportation service yet. Although the time between the first intention and the first request being sent out can be short, it is possible that the service provider is allocated to other service requester(s) before the first service requester sends out the request of the first transportation service. In this case, for a situation that the demand for vehicles exceeds the supply, for example, a situation of a bad weather or a traffic peak period, a measure may be token to ensure that the online transportation service platform (e.g., server 110) may provide a higher priority to a carpooling transportation service over a single transportation service in allocating a service provider.

In step 510, the intention receiving module 310 may determine a second transportation service of a second service requester that is combined with the first transportation service.

In some embodiments, at least one of the first service requester or the second service requester has not sent out a request. In some embodiments, the second transportation service may correspond to an intention or a request that has not been accepted by any service provider. In some embodiments, the intention receiving module 310 may determine the second transportation service based on the origin of the first transportation service, the destination of the first transportation service, the origin of the second transportation service, the destination of the second transportation service, the pick-up location of the second transportation service, the start time of the first transportation service, the start time of the second transportation service, or the like, or any combination thereof.

In step 520, the provider identifying module 320 may determine a first hold off time.

In some embodiments, the first hold off time may be default settings of system 100 (e.g., 10 seconds), or may be adjustable depending on different situations. For example, for a relative big city (e.g., Beijing), the first hold off time determined by the provider identifying module 320 may be relative short (e.g., 7 seconds). For a relative small city (e.g., Suzhou), the first hold off time determined by the provider identifying module 320 may be relative long (e.g., 15 seconds).

In step 530, the provider identifying module 320 may provide a higher priority to the first service requester and the second service requester over a plurality of other service requesters communicated to the online transportation service platform (e.g., server 110) in allocating the service provider within the first hold off time.

If the first service requester formally sends out the information of the first transportation service within the first hold off time, and the second service requester formally sends out the information of the second transportation service within the first hold off time, the provider identifying module 320 may allocate the service provider to the first service requester and the second service requester. If one of the first service requester and the second service requester does not formally send out the information of the transportation service within the hold off time, the provider identifying module 320 may cancel the priority to the first service requester and the second service requester in allocating the service provider.

In some embodiments, the intention receiving module 310 may determine more than one transportation service that is combined with the first transportation service. In this case, the provider identifying module 320 may perform the process 500 to provide a higher priority to the first service requester and the service requesters corresponding to the more than one transportation service that is combined with the first transportation service in allocating a service provider.

Back to FIG. 4, in some embodiments, for a real-time transportation service, step 440 of the process 400 may be performed based on the process 600 illustrated in FIG. 6 for determining a first time point according to some embodiments of the present disclosure. In some embodiments, the process 600 may be implemented in the system 100 illustrated in FIG. 1. For example, the process 600 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3).

In step 610, the time determination module 340 may determine a first estimated travel time that the service provider will need to arrive at the pick-up location from the location of the service provider at the first service intention time. In some embodiments, the time determination module 340 may determine the first estimated travel time according to the distance between the location of the service provider at the first service intention time and the pick-up location, the speed of the service provider, the road condition from the location of the service provider at the first service intention time to the pick-up location, or the like, or any combination thereof. The road condition may include the number of traffic light, the number of vehicle on the road, or the like, or any combination thereof.

In step 620, the time determination module 340 may determine a first time point according to the first estimated travel time. In some embodiments, for a real time intention, the time determination module 340 may determine the first time point according to the first intention time and the first estimated travel time. For example, the intention receiving module 310 may receive and/or detect an intention for a transportation service appointment at 10:00 am. The time determination module 340 may determine 10:00 am as the first service intention time. The first estimated travel time determined by the time determination module 340 may be 2 minutes. The time determination module 340 may determine 10:02 am as the first time point according to the first service intention time and the first estimated travel time.

Back to FIG. 4, in some embodiments, for a real-time transportation service, step 445 of the process 400 may be performed based on the process 700 illustrated in FIG. 7 for determining a second time point according to some embodiments of the present disclosure. In some embodiments, the process 700 may be implemented in the system 100 illustrated in FIG. 1. For example, the process 700 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3).

In some embodiments, there may be an available service provider identified by the provider identifying module 320 at the first service intention time, but there may be no transportation service that is combined with the first transportation service at the first service intention time. In this case, the time determination module 340 may determine a later second time point to ensure that the intention receiving module 310 may determine a transportation service that is combined with the first transportation service after the first service intention time. The later second time point may be later than a second time point determined in a situation that there is at least one transportation service that is combined with the first transportation service identified by the intention receiving module 310 at the first service intention time.

In step 710, the time determination module 340 may determine whether there is at least one transportation service that is combined with the first transportation service at the first service intention time. If the time determination module 340 determines that there is at least one transportation service that is combined with the first transportation service at the first service intention time, the process 700 may proceed to step 740.

In step 740, the time determination module 340 may determine a second estimated travel time based on the first estimated travel time and the wait time. In some embodiments, the second estimated travel time may be a linear combination of the first estimated travel time and the wait time. In some embodiments, the time determination module 340 may determine the second estimated travel time according to Equation (1) below:

T_{E2}=A₁T_{E1}+B₁T_{wait}, Equation (1)

wherein T_{E2} may refer to the second estimated travel time determined based on the first estimated travel time and the wait time, T_{E1} may refer to the first estimated travel time, T_{wait} may refer to the wait time, A₁ may refer to a first coefficient of the first estimated travel time, B₁ may refer to a first coefficient of the wait time, and A₁ and B₁ may be larger than 0. For example, if A₁=1, B₁=1, the first estimated travel time is 2 minutes, and the wait time is 5 minutes, the time determination module 340 may determine that the second estimated travel time is 7 minutes.

If the time determination module 340 determines that there is no transportation service that is combined with the first transportation service at the first service intention time, the process 700 may proceed to step 720. In step 720, the time determination module 340 may determine a buffer time based on the first estimated travel time and the wait time. In some embodiments, the buffer time may reflect the departure time of the service provider to depart from the pick-up location. In some embodiments, the buffer time may be a linear combination of the first estimated travel time and the wait time. In some embodiments, the time determination module 340 may determine the buffer time according to Equation (2) below:

T_{buffer}=A₂T_{E1}+B₂T_{wait}, Equation (2)

wherein T_{buffer} may refer to the buffer time, A₂ may refer to a second coefficient of the first estimated travel time, B₂ may refer to a second coefficient of the wait time, and A₂ and B₂ may be larger than 0. For example, if A₂=1, B₂=1, the first estimated travel time is 2 minutes, and the wait time is 5 minutes, the time determination module 340 may determine that the buffer time is 7 minutes. In some embodiments, the buffer time and the second estimated travel time determined in step740 may be same or different.

In step 730, the time determination module 340 may determine whether the buffer time is larger than a threshold. In some embodiments, the threshold may be an estimated time between the first service intention time and a third service intention time of a third intention. The third intention may be a hypothetical intention of which a third transportation service is combined with the first transportation service. The threshold may be default settings of system 100, or may be adjustable depending on different situations. For example, in a traffic peak period (e.g., 7:00 am-9:00 am), the threshold may be relatively small (e.g., 5 minutes), otherwise in an idle period (e.g., 10:00 am-12:00 am), the threshold may be relatively large (e.g., 10 minutes).

If the time determination module 340 determines that the buffer time is larger than the threshold, which may indicate that the probability of determining a transportation service that is combined with the first transportation service before the service provider departs from the pick-up location is relative high, the process 700 may proceed to step 740. If the time determination module 340 determines that the buffer time is less than or equal to the threshold, which may indicate that the probability of determining a transportation service that is combined with the first transportation service before the service provider departs from the pick-up location is relative low, the process 700 may proceed to step 750.

In step 750, the time determination module 340 may determine a second hold off time. In some embodiments, the second hold off may be used to determine a later second time point to ensure that the intention receiving module 310 may determine a transportation service that is combined with the first transportation service before the service provider departs from the pick-up location. In some embodiments, the time determination module 340 may determine the second hold off time based on the threshold and the buffer time. In some embodiments, the time determination module 340 may determine the second hold off time based on the difference value between the threshold and the buffer time. In some embodiments, the time determination module 340 may determine the second hold off time based on Equation (3) below:

T_{hold}=C(Tₜₕᵣₑ−T_{buffer}), Equation (3)

wherein T_{hold} may refer to the second hold off time, Tₜₕᵣₑ may refer to the threshold, C may refer to a first coefficient of the second hold off time, and C may be larger than 0. For example, if C=1, the threshold is 10 minutes, and the buffer time is 5 minutes, the time determination module 340 may determine that the second hold off time is 5 minutes.

In step 760, the time determination module 340 may determine a second estimated travel time based on the second hold off time, the first estimated travel time, and the wait time. In some embodiments, the second estimated travel time may be a linear combination of the second hold off time, the first estimated travel time, and the wait time. In some embodiments, the time determination module 340 may determine the second estimated travel time according to Equation (4) below:

T_{E2}′=A₃T_{E1}+B₃T_{wait}+DT_{hold}, Equation (4)

wherein T_{E2}′ may refer to the second estimated travel time determined based on the first estimated travel time, the wait time, and the second hold off time, A₃ may refer to a third coefficient of the first estimated travel time, B₃ may refer to a third coefficient of the wait time, D may refer to a second coefficient of the second hold off time, and D, A₃, and B₃ may be larger than 0. For example, if A₃=1, B₃=1, D=1, the first estimated travel time is 2 minutes, the wait time is 5 minutes, and the second hold off time is 3 minutes, the time determination module 340 may determine that the second estimated travel time is 10 minutes.

In step 770, the time determination module 340 may determine the second time point according to the second estimated travel time. In some embodiments, for a real-time transportation service, the time determination module 340 may determine the second time point according to the second estimated travel time and the first service intention time. For example, the intention receiving module 310 may receive and/or detect an intention for a transportation service appointment at 10:00 am. The time determination module 340 may determine 10:00 am as the first service intention time. The second estimated travel time determined by the time determination module 340 may be 8 minutes. The time determination module 340 may determine 10:08 am as the second time point according to the first service intention time and the second estimated travel time.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for carpooling, comprising:
one or more storage media comprising a set of instructions for operating an online carpool transportation service platform; and
one or more processors configured to communicate with the one or more storage media, wherein when executing the set of instructions, the one or more processors are directed to:
receive a first intention for a first transportation service of a first subject from a first service requester at a first service intention time;
identify an available service provider at the first service intention time;
send the service provider a first time point to arrive at a pick-up location and a wait time to stop at the pick-up location before departing from the pick-up location; and
send the first service requester a second time point to arrive at the pick-up location.

2. The system of claim 1, wherein when executing the set of instructions, the one or more processors are further directed to:
determine a second intention for a second transportation service of a second subject from a second service requester;
determine a first hold off time; and
within the first hold off time, provide a higher priority to the first service requester and the second service requester over a plurality of other service requesters communicated to the online transportation service platform in allocating the service provider.

3. The system of claim 2, wherein to receive the first intention the one or more processors are further directed to:
receive a destination of the first transportation service from the first service requester; and
before receiving a request of the first transportation service from the first service requester, determine that the first service requester intents to request the first transportation service;
wherein to receive the second intention the one or more processors are further directed to:
receive a destination of the second transportation service from the second service requester, and
before receiving a request of the second transportation service from the second service requester, determine that the second service requester intents to request the first transportation service.

4. The system of claim 1, wherein when executing the set of instructions, the one or more processors are further directed to:
determine an estimated travel time that the service provider will need to arrive at the pick-up location; and
determine the first time point and the second time point based on the estimated travel time.

5. The system of claim 4, wherein to determine the second time point the one or more processors are further directed to:
determine a buffer time based on the estimated travel time and the wait time.

6. The system of claim 5, wherein when executing the set of instructions, the one or more processors are further directed to:
determine that the buffer time is larger than a threshold; and
determine the second time point based on the estimated travel time and the wait time.

7. The system of claim 5, wherein when executing the set of instructions, the one or more processors are further directed to:
determine that the buffer time is less than or equal to a threshold;
determine a second hold off time based on the threshold and the buffer time; and
determine the second time point based on the second hold off time, the estimated travel time, and the wait time.

8. The system of claim 7, wherein the threshold is an estimated time between the first service intention time and a third service intention time of a third intention, the third intention is a hypothetical intention of which a third transportation service is combined with the first transportation service.

9. The system of claim 1, wherein the first subject is one or more passengers and the first transportation service is a taxi service.

10. The system of claim 1, wherein the first subject is one or more goods and the first transportation service is a goods delivery service.

11. A method for carpooling implemented on a computing device of an online transportation service platform including at least one storage medium and at least one processor, the method comprising:
receiving, by the at least one processor, a first intention for a first transportation service of a first subject from a first service requester at a first service intention time;
identifying, by the at least one processor, an available service provider at the first service intention time;
sending, by the at least one processor, the service provider a first time point to arrive at a pick-up location and a wait time to stop at the pick-up location before departing from the pick-up location; and
sending, by the at least one processor, the first service requester a second time point to arrive at the pick-up location.

12. The method of claim 11, further comprising:
determining, by the at least one processor, a second intention for a second transportation service of a second subject from a second service requester;
determining, by the at least one processor, a first hold off time; and
within the first hold off time, providing, by the at least one processor, a higher priority to the first service requester and the second service requester over a plurality of other service requesters communicated to the online transportation service platform in allocating the service provider.

13. The method of claim 12, wherein the receiving the first intention includes:
receiving, by the at least one processor, a destination of the first transportation service from the first service requester; and
before receiving a request of the first transportation service from the first service requester, determining, by the at least one processor, that the first service requester intents to request the first transportation service;
wherein the receiving the second intention includes:
receiving, by the at least one processor, a destination of the second transportation service from the second service requester, and
before receiving a request of the second transportation service from the second service requester, determining, by the at least one processor, that the second service requester intents to request the first transportation service.

14. The method of claim 11, further comprising:
determining, by the at least one processor, an estimated travel time that the service provider will need to arrive at the pick-up location; and
determining, by the at least one processor, the first time point and the second time point based on the estimated travel time.

15. The method of claim 14, wherein the determining the second time point includes:
determining, by the at least one processor, a buffer time based on the estimated travel time and the wait time.

16. The method of claim 15, further comprising:
determining, by the at least one processor, that the buffer time is larger than a threshold; and
determining, by the at least one processor, the second time point based on the estimated travel time and the wait time.

17. The method of claim 15, further comprising:
determining, by the at least one processor, that the buffer time is less than or equal to a threshold;
determining, by the at least one processor, a second hold off time based on the threshold and the buffer time; and
determining, by the at least one processor, the second time point based on the second hold off time, the estimated travel time, and the wait time.

18. The method of claim 17, wherein the threshold is an estimated time between the first service intention time and a third service intention time of a third intention, the third intention is a hypothetical intention of which a third transportation service is combined with the first transportation service.

19. The method of claim 11, wherein the first subject is one or more passengers and the first transportation service is a taxi service.

20. The method of claim 11, wherein the first subject is one or more goods and the first transportation service is a goods delivery service.
